(19) United States
(12) Patent Application Publication
(10) Pub. No.: US 2008/0194324 A1
(43) Pub. Date: Aug. 14, 2008

(54) EDUCATIONAL GAME

(76) Inventor: Elizabeth N. Treher, Albuquerque, NM (US)

Correspondence Address: PEACOCK MYERS, P.C., 201 THIRD STREET, N.W., SUITE 1340, ALBUQUERQUE, NM, 87102, US

(21) Appl. No.: 11/766,675

(22) Filed: Jun. 21, 2007

Related U.S. Application Data
(60) Provisional application No. 60/805,441, filed on Jun. 21, 2006.

(51) Int. Cl. A63F 3/04; A63F 13/00; A63F 3/00

(52) U.S. Cl. 463/31; 273/242; 273/243

(57) ABSTRACT

An educational game and method of the present invention includes a playing surface drawn to a map scale to enable the use of the playing surface as a map. A path having a plurality of game spaces extends along the playing surface and includes a start space and an end space and each of the game spaces has an action property. The educational game also includes a plurality of board pieces for movement along the path and each of the board pieces is associated with a player.

### CROSS-REFERENCE TO RELATED APPLICATIONS

This application claims priority to and the benefit of the filing of U.S. Provisional Patent Application Ser. No. 60/805,441, entitled “Map-Based Game”, filed on Jun. 21, 2006, and the specification thereof is incorporated herein by reference.

### COPYRIGHTED MATERIAL

A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

The present invention relates in general to educational games, such as board games and the like.

### BRIEF SUMMARY OF THE INVENTION

An educational game of the present invention includes a playing surface drawn to a map scale to enable the use of the playing surface as a map. A path having a plurality of game spaces extends along the playing surface and includes a start space and an end space and each of the game spaces has an action property. The educational game also includes a plurality of board pieces for movement along the path and each of the board pieces is associated with a player.

Alternatively, the educational game further comprises at least one random movement generator for determining a direction and a magnitude of movement of the board pieces along the path. The educational game may further comprise at least a second random movement generator operated concurrently with random movement generator and the at least one random question category generator for determining a different magnitude of direction in an opposite direction moved by the player. The random movement generator may be a movement die wherein the player rolls the movement die to determine the direction and the magnitude of movement.

Alternatively, the educational game further comprises at least one random question category generator for selecting a one of a plurality of question categories. The educational game may further comprise a plurality of question cards each having a plurality of educational questions and answers, each of the questions associated with a question category. The random question generator may be a question die and wherein the player rolls the question die to determine the question category. The question categories may be selected from the group consisting of history, arts and entertainment, travel and statistics, sports and recreation, people and things, points of interest, and combinations thereof.

Alternatively, the educational game further comprises a plurality of game space cards each corresponding to at least one of the game spaces. Alternatively, the player is a group of players. Alternatively, the action property of each of the game spaces is selected from the group consisting of a question category, an Oops card action, and a Discovery card action. The game space cards may be selected from the group consisting of an Oops card, a Sight Card, a Site Card, and a discovery card.

Alternatively, the playing surface depicts an actual location. Alternatively, the playing surface depicts a fictional location. Alternatively, each of the game pieces start on the start space. Alternatively, the playing surface is a game board. The playing surface may be displayed on a computer screen.

In another embodiment, the present invention provides a method for playing an education game that includes providing a playing surface drawn to a map scale to enable the use of the playing surface as a map. The playing surface includes a path having a plurality of game spaces extending therealong, the playing surface and includes a start space and an end space. Each of the game spaces has an action property. The method also includes providing a plurality of board pieces for movement along the path, each of the board pieces associated with a player, providing at least one random movement generator for determining a direction and a magnitude of movement of the board pieces along the path, and providing at least one random question category generator for selecting a one of a plurality of question categories. The method also includes providing a plurality of question cards each having a plurality of educational questions and answers, each of the questions associated with a question category and providing a plurality of game space cards each corresponding to at least one of the game spaces, each of the game space cards including at least one statement. The method also includes operating the at least one random movement generator and the at least one random question category generator by a player having a board piece on a first game space, moving the board piece along the path from the first game space to a second game space based on the magnitude of movement, performing an action selected from the group consisting of answering a question from a question card based on the selected question category and responding to the at least one statement from the game space card, the action determined by the action property of the second game space. The player tracks correctly answered questions, and gains knowledge from the at least one statement and alternatively moves to a third game space based on the at least one statement of the game space card.

Alternatively, the method further comprises at least a second random movement generator operated concurrently with random movement generator and the at least one random question category generator for determining a different magnitude of direction in an opposite direction moved by the player when the player answers the question incorrectly. Alternatively, the player tracks correctly answered questions by retaining the question card when the player correctly answers the question. Alternatively, another player may track correctly answered questions when the player answers the question incorrectly. Alternatively, the player is a group of players.

Alternatively, the action property of each of the game spaces is selected from the group consisting of a question category, an Oops card action, a Sight Card, a Site Card, and a Discovery card action. Alternatively, the random movement generator is a movement die and wherein the operating step comprising the player rolling the movement die to determine the direction and the magnitude of movement. Alternatively, the random question generator is a question die and wherein the operating step comprising the player rolling the question die to determine the question category. Alternatively, the question categories are selected from the group consisting of history, arts and entertainment, travel and statistics, sports and recreation, people and things, points of interest, and combinations thereof.

Alternatively, the playing surface depicts an actual location. Alternatively, the playing surface depicts a fictional location. Alternatively, each of the game pieces start on the start space. Alternatively, the game ends when a player tracks a predetermined number of each of the categories of the question cards. The game may end when the player having tracked the predetermined number of each of the categories of the question cards reaches the end space.

Alternatively, the playing surface is a game board. Alternatively, the playing surface is displayed on a computer screen. Alternatively, the game space cards are selected from the group consisting of an Oops card and a discovery card. Alternatively, the third game space is a key point of interest on the playing surface.

The term “playing surface” as used throughout the specification and claims is intended to include a hard surface such as a typical board game and also a computer screen or projection.

The term “player” as used throughout the specification and claims is intended to include a single player and a team of or a plurality of players.

The term “card” or “cards” as used throughout the specification and claims is intended to include a tangible card or physical cards and also computer-generated questions.

The term “board piece” as used throughout the specification and claims is intended to include a tangible or physical board piece or computer-generated icons or indicators.

The present invention pertains to a game for entertaining and education based on graphically-enhanced maps of cities, states, countries and tourist/visitor venues. This illustrated map-based game allows one to play and learn about world-wide cities, states, countries, and other actual or fictional places of interest. The invention includes a game board (physical board, or computer- or Internet-based playing image or board), rolling or simulation of rolling of dice, and moving the teams' and players' pieces on the map. There are preferably three types of cards used for the game. These include question cards, which cover subjects related to the game topic; discovery cards, which provide anecdotal and miscellaneous information; and action cards (sometimes called Oops! cards herein), which describe real-life situations and actions needed.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The objects and features of the present invention will become clearer from the following description of the preferred embodiments given with reference to the attached drawings, wherein:

FIG. 1 is an illustration of an embodiment of the game of the present invention, showing a map of Boston, through which a player travels;

FIG. 2 is an illustration of an embodiment of the game of the present invention, showing a map of Philadelphia, through which a player travels;

FIG. 3 is a flowchart showing steps of a method of the present invention;

FIG. 4 is a block diagram of question cards and categories; and

FIG. 5 is a block diagram of Oops! and discovery cards.

### DETAILED DESCRIPTION OF THE INVENTION

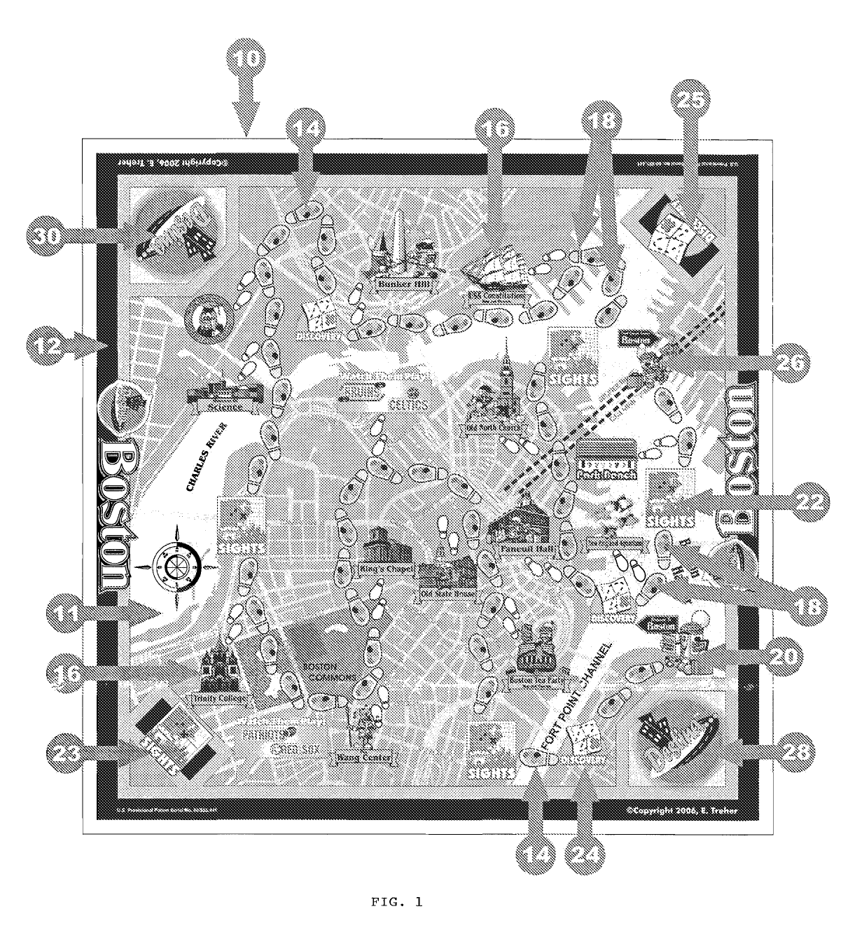

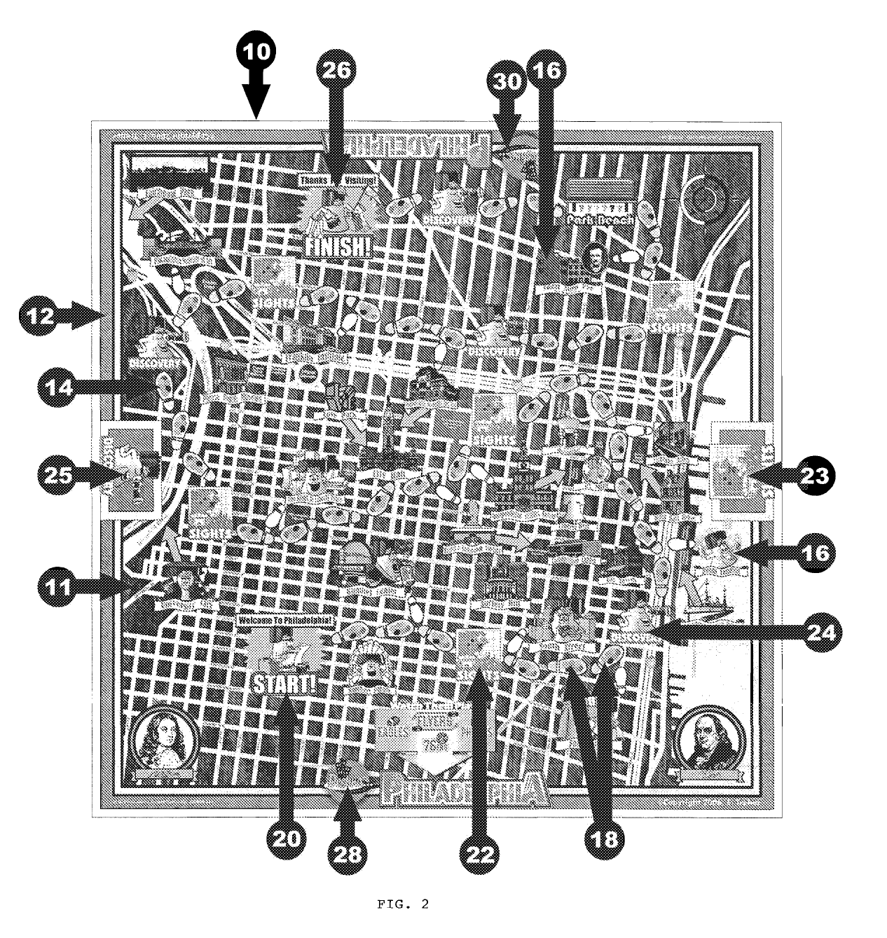

Referring now to FIGS. 1 and 2, board game apparatus in accordance with an embodiment of the present invention is indicated generally at 10. FIG. 1 depicts a map of Boston, while FIG. 2 depicts a map of Philadelphia. Those skilled in the art will appreciate that maps of numerous locations, both actual and fictional, may be depicted while remaining within the scope of the present invention. As shown in FIGS. 1 and 2, game apparatus 10 comprises game board 12 having a playing surface 11 that depicts a map of the venue overlaid by a path 14 that extends along playing surface 11 and is positioned near the location of key points of interest 16 on playing surface 11. Game board 12 and playing surface 11 are preferably based on an actual scaled map of a location and are drawn, rendered, or otherwise displayed at a substantially exact map scale sufficient to enable the use of game board 12 and playing surface 11 as a map to guide a user by automotive vehicle or on foot.

Path 14 includes start space 20 that comprises an initial start position, including, for example, but not limited to: “hello”, “welcome”, “begin visit” or other designations; question spaces 18; action spaces such as Oops!, Sights or Sites spaces 22 and discovery spaces 24 are distributed among question spaces 18 comprising the majority of the path 14. The end space 26 comprises an end or finish, including, for example, but not limited to: “goodbye”, “end visit”, “finish”, “thank you for visiting”, or other similar term to signify the end of the game. Preferably, a space along path 14 located closer to end space 26 may be a holding or park bench space, as further disclosed herein.

Spaces 18, 22, and 24 allow players, such as individual players or a team or group of players to move respective game pieces along path 14 from start space 20 to end space 26. Preferably, the movement of the players along spaces 18, 22, and 24 of path 14 is a function of a pair of random movement generator, such as the throwing of a pair of movement dice or the like, as well as the results of landing on differing types of spaces 18, 22, and 24. Each of the spaces 18, 22, and 24 preferably has an action category associated therewith. For example, the action category of question spaces 18 is related to a plurality of question cards having a predetermined number of categories and listed on a plurality of question cards that are placed on playing surface 11, such as at locations 28 and 30. The action category of Oops!, Sights, or Sites spaces 22 is related to a plurality of game space cards such as Oops!, Sights or Sites cards placed on playing surface 11 at location 23. The action category of discovery spaces 24 is related to a plurality of game space or discovery cards placed on playing surface 11 at location 25.

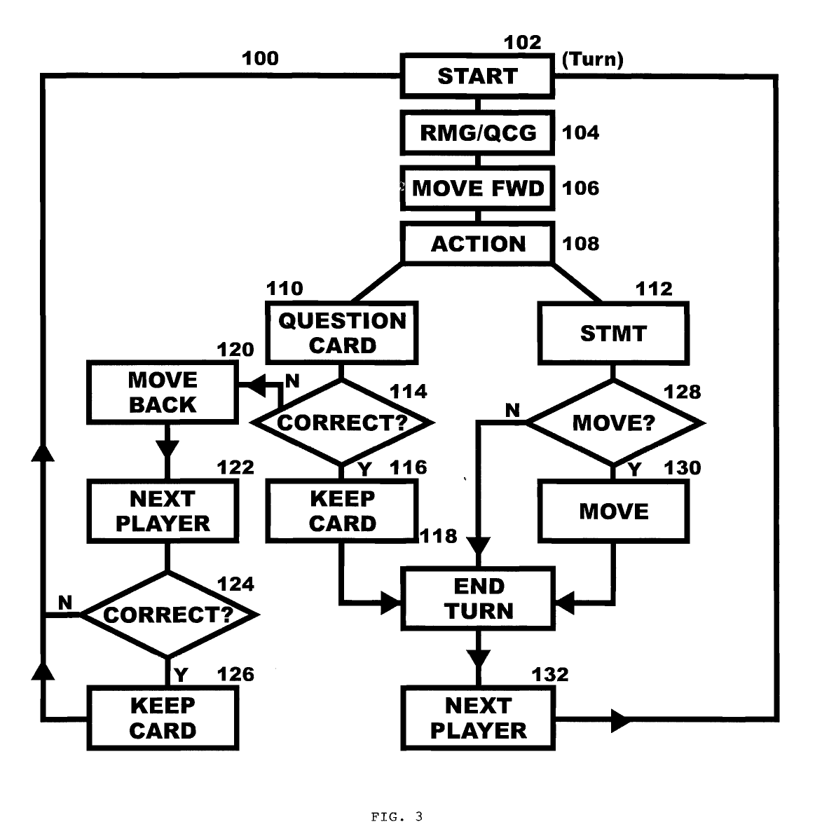

FIG. 3 shows steps of a method in accordance with an embodiment of the present invention, indicated generally at 100. In a step 102, a player's (not shown) turn starts and in a step 104, the player operates the pair of random movement generators and the random question category generator. In a step 106, the player moves the board or game piece along path 14 based on the first magnitude of movement generated by the random movement generator to a space and, in a step 108, the player performs the action associated with the action property of the space. If the action property of the space is a question, in a step 110, preferably another player selects a question card based on the results of the random question generator, asks the player the question, and the player answers the question on the card, and conversely, if the action property of the space is a statement from a game space card, the player responds to the statement in a step 112. In a step 114, if the player's answer to the question in the step 110 is correct, the player keeps the card in the step 116 and the players turn ends in the step 118. In a step 132, the method 100 moves to the next player in the game, who begins the next player's turn at the start step 102.

If the player's answer to the question in the step 110 is not correct, the player moves back, in a step 120, along the path 14 in an opposite direction based on the second magnitude of movement of the second random movement generator and, in the step 122, the question is asked of the next player in the game unless the question is a true or false question. If, in the step 124, the next player answers the question correctly, the player keeps or retains the card in the step 126 and returns to the step 102 to start the next player's turn. If the next player does not answer the question correctly, the player returns to the step 102 to start the next player's turn.

If the action property of the space is a statement of a game space card in the step 112, the player responds to the statement. In the step 128, the player determines if the game space card allows the player to move along the path 14 and, if so, the player moves to the space directed by the game space card in the step 130 and the player's turn ends in the step 118. Preferably, if the game space card directs movement along the path 14, the direction is to a key point of interest 16. If there is no movement directed by the card, the player's turn ends in the step 118. In the step 132, the method 100 moves to the next player in the game, who begins the next player's turn at the start step 102.

Preferably, in the step 104, the random movement generators are two standard six-sided dice of different colors and the random question category generator is a third die having six different colors, one per side. The method 100 continues with each player preferably collecting a predetermined number of cards (or points) per category. For example, each player may collect two cards per question category for a standard game, although one or three or more cards may be required to shorten or lengthen the time of play. As an example, the winning player is the first to collect the predetermined number of cards of each question category or color and to enter the final space, end space 26. Those skilled in the art will appreciate that possession of actual cards is not required and that alternate means or methods of tallying or tracking correctly answered questions by category may be practiced while remaining within the scope of the present invention. Preferably, if a team or player reaches the holding space or park bench space without the required or predetermined number of question cards, that team or player stays on the bench and continues to throw the question category die and answer questions until having the cards required to move the end space 26.

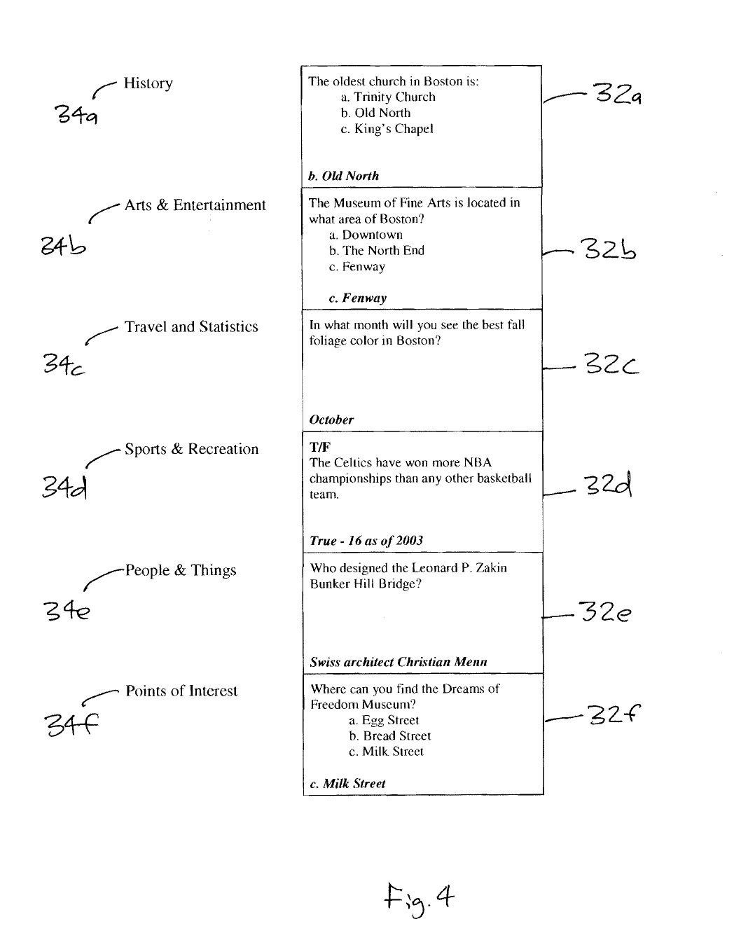

FIG. 4 shows samples of question cards 32a, 32b, 32c, 32d, 32e and 32f. Question card categories are grouped by topic which include, but are not limited to: “history” 34a; “arts and entertainment” 34b; “travel and statistics” 34c; “sports and recreation” 34d; “people and things” 34e; “points of interest” 34f, and combinations thereof. Question categories 34a, 34b, 34c, 34d, 34e and 34f are non-limiting examples and those skilled in the art will appreciate that the apparatus 10 and method 100 is capable of other embodiments and of being practiced and carried out utilizing any number and type of question categories relevant to the site depicted.

Each category 34a, 34b, 34c, 34d, 34e and 34f of cards 32a, 32b, 32c, 32d, 32e and 32f is preferably a different color, selected during play by operating a random question category generator, such as by rolling e.g. a six-sided, six-color die, linked by color to each of the card categories 34a, 34b, 34c, 34d, 34e and 34f. The question cards 32a, 32b, 32c, 32d, 32e and 32f are separated into groups of each colored category 34a, 34b, 34c, 34d, 34e and 34f. Question cards 32a, 32b, 32c, 32d, 32e and 32f are kept by the player or team that correctly answers that question.

As an example, and as shown in FIG. 4, in the Boston game, a history card 32a includes a question and an answer: “The oldest church in Boston is: a) Trinity Church; b) Old North; or c) King's Chapel” and the answer is “b) Old North.”

The arts and entertainment card 32b includes a question and an answer: “The Museum of Fine Arts is located in what area of Boston? a) Downtown; b) The North End; c) Fenway” and the answer is “c) Fenway.”

The travel and statistics card 32c includes a question and an answer: “In what month will you see the best fall foliage color in Boston?” and the answer is “October.”

The sports and recreation card 32d includes a question and an answer: “T/F The Celtics have won more NBA championships than any other basketball team” and the answer is “True—16 as of 2005.”

The people and things card 32e includes a question and an answer: “Who designed the Leonard P. Zakin Bunker Hill Bridge?” and the answer is “Swiss architect Christian Menn.”

The points of interest card 32f includes a question and an answer: “Where can you find the Dreams of Freedom Museum? a) Egg Street; b) Bread Street; c) Milk Street” and the answer is “c) Milk Street.”

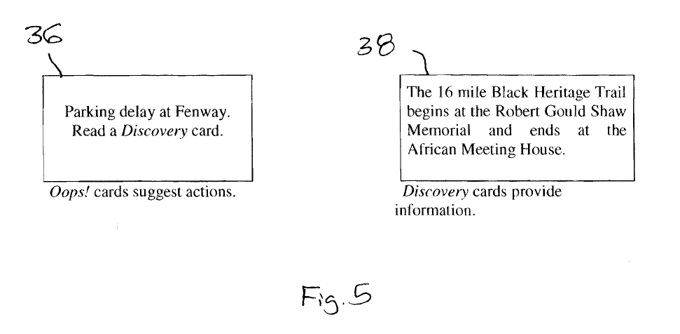

FIG. 5 shows examples of game space cards such as an Oops! card 36 and a discovery card 38 for a specific embodiment of the board game with a Boston map, shown in FIG. 1. Although questions related to a map of Boston are shown, the invention is not limited to any particular location. The location on the playing surface 11 may be an actual location or a fictional location. A player reads an Oops! card 36 (or a screen question/comment) when, after rolling the movement dice, the player advances to a space 22 that is marked Oops! Preferably, Oops! cards 36 suggest actions. Alternatively, Oops! cards 36 direct a player to move to a given space on the path 14, advantageously ensuring that the path 14 is a random path and not a fixed path.

Discovery cards 38 are collected when a player lands on discovery spaces 24. Discovery cards 38 provide information about the geographical location of the board game 10. As shown therein, for example, in the Boston game, the game has an Oops card 36 which says “Parking delay at Fenway. Read a discovery card.” The discovery card 38 has information, e.g. “The 16 mile Black Heritage Trail begins at the Robert Gould Shaw Memorial and ends at the African Meeting House.”, which advantageously provides education to the player or players. The Oops! cards 36 and discovery cards 38 are placed on the appropriate spaces 23 and 25 on the playing surface 11. As each card 36 or 38 is used, it is returned to the bottom of its stack.

An embodiment of the game of the present invention includes a depiction (true or imaginary) of a map on a playing surface 11 of the desired location or venue and is preferably drawn to a map scale to enable to use of the playing surface 11 as a map. Path 14 is overlaid on the game board 12 and playing surface 11 for advancing game pieces. The game method 100 includes rolling three dice or the use of at least one and preferably two random movement generators and a question category generator that simulate the rolling of dice, each with a different function, for example: one to advance along the path 14, one to select the question category 34a, 34b, 34c, 34d, 34e and 34f, and one to go back along the path 14 if the question is incorrectly answered. A portion of the path 14 includes spaces that indicate a game space card, such as an Oops!, Sight, or Site space 22 or a discovery space 24 and the remaining spaces 18 highlight a specific location or a question space. The Oops! cards 36 may send a player to a specific location on the path 14, so that movement is not necessarily in a consistently forward direction. During play, players move along path 14 from start space 20 to end space 26 and, while game space cards 36 and 38 may direct players moving game pieces along path 14 to alternate random spaces, such as those adjacent points of interest 16, players preferably complete only one trip along path 14 from start space 20 to end space 26.

An embodiment of the apparatus 10 and method 100 of the present invention advantageously provides entertainment and education about specific places—cities, states, countries, tourist venues as well as a unique method of play. The apparatus 10 and method 100 advantageously promotes learning about specific geographic locations of any size in a fun, engaging game environment. The apparatus 10 and method 100 provides for learning about specific places and venues as well as a method of playing the game in a manner to provide a life-like experience of the place or venue. Preferably, the apparatus 10 and method 100 is played with more than one player, and most preferably in teams, however, the apparatus 10 and method 100 may be played by one person for that person to learn about the map and, therefore, the subject of the map. The apparatus 10 and method 100 of the present invention provides a map-based game comprising a random path 14, which has a primary purpose of educating while entertaining about a real or imaginary location.

Although the above non-limiting examples recite a board game in which dice are thrown and cards are used, those skilled in the art will appreciate that the apparatus 10 and method 100 may also be computer-based or Internet-based. In such embodiments, the game board 12 and playing surface 11 is a computer or screen image, the dice are selections (e.g. simulated dice, a push of a button, random selections, or other random movement and question category generators etc.), and the cards 32, 36, and 38 are images, questions, or comments on a screen. The invention, therefore, is not limited to an embodiment of a physical board game.

It is to be understood that the invention is not limited in its application to the details of construction and to the arrangements of the components illustrated herein. Appearance will vary, depending on location or venue.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

1. An educational game, comprising:
a playing surface drawn to a map scale to enable the use of said playing surface as a map;
a path having a plurality of game spaces extending along said playing surface and including a start space and an end space, each of said game spaces having an action property;
a plurality of game pieces for movement along said path, each of said game pieces associated with a player.

2. The educational game of claim 1 further comprising a first random movement generator for determining a first direction and a first magnitude of movement of at least one said game piece along said path.

3. The educational game of claim 2 further comprising at least a second random movement generator for determining a second magnitude of movement and direction.

4. (canceled)

5. The educational game of claim 1 further comprising at least one random question category generator for selecting a one of a plurality of question categories.

6. The educational game of claim 5 further comprising a plurality of question cards, having a plurality of educational questions and answers, and each of said questions associated with a said question category.

7. (canceled)

8. The educational game of claim 5 wherein said question categories are selected from the group consisting of history, arts, entertainment, travel, statistics, sports, recreation, people, things, points of interest, and combinations thereof.

9. The educational game of claim 1 further comprising a plurality of game space cards each corresponding to at least one of said game spaces.

10. (canceled)

11. The educational game of claim 1 wherein said action property of each of said game spaces is selected from the group consisting of a question category, an action category, and an information category.

12. The educational game of claim 11 further comprising a second type of action card.

13. The educational game of claim 1 wherein said playing surface depicts an actual location.

14. The educational game of claim 1 wherein said playing surface depicts a fictional location.

15. (canceled)

16. (canceled)

17. (canceled)

18. A method for playing an educational game, comprising: providing a playing surface drawn to a map scale to enable the use of said playing surface as a map, said playing surface including a path having a plurality of game spaces extending therealong, said playing surface including a start space and an end space, each of said game spaces having an action property and each of said game pieces associated with a player;
moving a plurality of game pieces along said path;
generating at least one random direction and a magnitude of movement for at least one said game piece along said path;
generating at least one random question category from a plurality of question categories;
providing a plurality of question cards having a plurality of educational questions and answers, each of said questions associated with the question category;
providing a plurality of game space cards corresponding to at least one of said game spaces, each of said game space cards including at least one statement;
starting play by having a game piece on a first game space; and
moving said board piece along said path from said first game space to a second game space based on said magnitude of movement and the player performing an action selected from the group consisting of answering a question from at least one of the question cards from the selected question category.

19. The method of claim 18 further comprising generating a second magnitude of movement and direction.

20. The method of claim 18 wherein said player tracks correctly answered questions by retaining said question card when said player correctly answers said question.

21. The method of claim 19 wherein the second direction is opposite the first direction and occurs when the player answers the question incorrectly.

22. The method of claim 18 wherein multiple players play the game.

23. The method of claim 18 wherein said action property of each of said game spaces is selected from the group consisting of a question category, an action category and an information category.

24. (canceled)

25. The method of claim 18 wherein the player rolls the question die to determine the question category.

26. The method of claim 18 wherein said question categories are selected from the group consisting of history, arts, entertainment, travel, statistics, sports, recreation, people, things, points of interest, and combinations thereof.

27. The method of claim 18 wherein said playing surface depicts an actual location.

28. The method of claim 18 wherein said playing surface depicts a fictional location.

29. The method of claim 18 comprising starting each of the game pieces on the start space.

30. The method of claim 18 wherein the game ends when a player tracks a predetermined number of each of the categories of question cards.

31. The method of claim 18 wherein said game ends when the player reaches the end space.

32. (canceled)

33. (canceled)

34. The method of claim 18 wherein said game space cards are selected from the group consisting of an action car, an information card and a question card.

35. (canceled)
